(19) United States
(12) Patent Application Publication
(10) Pub. No.: US 2018/0167184 A1
(43) Pub. Date: Jun. 14, 2018

(54) Transmission Method and Apparatus for Demodulation Reference Signal and Communications System

(71) Applicant: FUJITSU LIMITED, Kawasaki-shi (JP)

(72) Inventors: Hua Zhou, Beijing (CN); Wei XI, Beijing (CN)

(73) Assignee: FUJITSU LIMITED, Kawasaki-shi (JP)

(21) Appl. No.: 15/889,762

(22) Filed: Feb. 6, 2018

Related U.S. Application Data
(63) Continuation of application No. PCT/CN2015/087753, filed on Aug. 21, 2015.

(51) Int. Cl. H04L 5/00; H04L 27/26; H04W 56/00; H04W 72/04

(52) U.S. Cl. CPC H04L 5/0048; H04L 27/2605; H04W 4/46; H04W 72/0446; H04W 56/001

(57) ABSTRACT

A transmission method and apparatus for a demodulation reference signal and a communications system. The transmission method includes: transmitting a DMRS by a transmitting device to a receiving device; the number of symbols in each subframe for transmitting the DMRS is configured as 1 or more than 2. Hence, more than 2 symbols for transmitting the DMRS are configured in each subframe, which may increase a transmission density of DMRS, and satisfy a demand of a new traffic, such as V2X, for a moving speed; or a single symbol for transmitting the DMRS is configured in each subframe, which may satisfy a demand of a low-speed mobile traffic, such as the cellular IOT, and lower overhead.

### CROSS REFERENCE TO RELATED APPLICATIONS

This application is a continuation application of International Application PCT/CN2015/087753 filed on Aug. 21, 2015, the entire contents of which are incorporated herein by reference.

### TECHNICAL FIELD

This disclosure relates to the field of communications technologies, and in particular to a transmission method and apparatus for a demodulation reference signal (DMRS) and a communications system.

### BACKGROUND

As the large-scale and global population of the long-term evolution (LTE) communications technology, applications based on such a technology are more and more widely used; for example, intelligent transportation system becomes a very hot application direction. In recent studies of 3GPP SA1, vehicle-to-everything (V2X) communications has been established as an important study.

FIG. 1 is a schematic diagram of typical application scenarios of the V2X communications. As shown in FIG. 1, the V2X communications may include three typical application scenarios: vehicle-to-vehicle (V2V) communications, which is communications applicable to between vehicles moving fast (such as between vehicle 1 and vehicle 2 shown in FIG. 1); vehicle-to-pedestrian (V2P) communications, which is communications applicable to between a vehicle moving fast and a pedestrian holding user equipment (such as between vehicle 1 and the pedestrian shown in FIG. 1); and vehicle-to-infrastructure (V2I) communications, which is communications between a vehicle and an infrastructure (such as between vehicle 1 and a base station shown in FIG. 1).

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that in the current LTE technology, the number of symbols in each subframe used for transmitting a DMRS is always 2, and a highest moving velocity in a corresponding application scenario is 120 km/h. A transmission technology corresponding to V2X, including important DMRS transmission, is not designed in the current LTE technology.

While for a new traffic morphology, such as V2X, what needs to be taken into account is that the highest velocity should reach 280 km/h, and especially, a relative velocity between two vehicles moving towards each other in the V2V application is relatively high. Hence, if an existing DMRS transmission technology is still used in a new traffic morphology, such as V2X, a demand for transmission performance cannot be satisfied. In order to deal with such an application, the design of the DMRS needs to be reconsidered. Another application corresponding to this is the cellular Internet of things (IOT), in which a large quantity of static equipment needs to be taken into account; and if it is needed to guarantee direct communications between the equipment, using two symbols to transmit the DMRS may possibly result in severe waste of resources, taking a static environment into account. Therefore, design of the DMRS needs also to be taken into account in such a scenario.

Embodiments of this disclosure provide a transmission method and apparatus for a demodulation reference signal (DMRS) and a communications system, in which transmission of DMRS is redesigned, so as to meet demands of a new traffic, such as the V2X, or the cellular IOT.

According to a first aspect of the embodiments of this disclosure, there is provided a transmission method for a demodulation reference signal, including:

transmitting a DMRS by a transmitting device to a receiving device; the number of symbols in each subframe for transmitting the DMRS is configured as 1 or more than 2.

According to a second aspect of the embodiments of this disclosure, there is provided a transmission apparatus for a demodulation reference signal, including:

a transmitting unit configured to transmit a DMRS to a receiving device; the number of symbols in each subframe for transmitting the DMRS is configured as 1 or more than 2.

According to a third aspect of the embodiments of this disclosure, there is provided a communications system, including:

a transmitting device configured to transmit a DMRS; the number of symbols in each subframe for transmitting the DMRS is configured as 1 or more than 2; and

a receiving device configured to receive the DMRS.

According to another aspect of the embodiments of this disclosure, there is provided a computer readable program code, which, when executed in user equipment (UE), will cause a computer unit to carry out the transmission method for a demodulation reference signal as described above in the UE.

According to a further aspect of the embodiments of this disclosure, there is provided a computer readable medium, including a computer readable program code, which will cause a computer unit to carry out the transmission method for a demodulation reference signal as described above in UE.

According to still another aspect of the embodiments of this disclosure, there is provided a computer readable program code, which, when executed in a base station, will cause a computer unit to carry out the transmission method for a demodulation reference signal as described above in the base station.

According to yet another aspect of the embodiments of this disclosure, there is provided a computer readable medium, including a computer readable program code, which will cause a computer unit to carry out the transmission method for a demodulation reference signal as described above in a base station.

An advantage of the embodiments of this disclosure exists in that a single symbol for transmitting the DMRS is configured in each subframe, which may lower overhead, and is very applicable to a static communications scenario, such as the cellular IOT; alternatively, more than 2 symbols for transmitting the DMRS are configured in each subframe, which may increase a transmission density of DMRS, and satisfy a demand of a new traffic, such as V2X, for a moving speed.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of typical application scenarios of the vehicle-to-everything communications;

FIG. 2 is a schematic diagram of DMRS configuration in sidelink communications;

FIG. 3 is another schematic diagram of DMRS configuration in sidelink communications;

FIG. 4 is a flowchart of the transmission method for the demodulation reference signal of Embodiment 1 of this disclosure;

FIG. 5 is a schematic diagram of a DMRS pattern in a subframe with normal CP in Embodiment 1 of this disclosure;

FIG. 6 is another schematic diagram of the DMRS pattern in the subframe with normal CP in Embodiment 1 of this disclosure;

FIG. 7 is a further schematic diagram of the DMRS pattern in the subframe with normal CP in Embodiment 1 of this disclosure;

FIG. 8 is still another schematic diagram of the DMRS pattern in the subframe with normal CP in Embodiment 1 of this disclosure;

FIG. 9 is yet another schematic diagram of the DMRS pattern in the subframe with normal CP in Embodiment 1 of this disclosure;

FIG. 10 is a schematic diagram of a DMRS pattern in a subframe with extended CP in Embodiment 1 of this disclosure;

FIG. 11 is another schematic diagram of the DMRS pattern in the subframe with extended CP in Embodiment 1 of this disclosure;

FIG. 12 is a further schematic diagram of the DMRS pattern in the subframe with extended CP in Embodiment 1 of this disclosure;

FIG. 13 is a schematic diagram of the transmission apparatus for the demodulation reference signal of Embodiment 2 of this disclosure;

FIG. 14 is a schematic diagram of a structure of the transmitting device of Embodiment 2 of this disclosure; and

FIG. 15 is a schematic diagram of the communications system of Embodiment 3 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

An LTE application relatively close to the V2X communications is device-to- device (D2D) communications, also referred to as sidelink communications in LTE standards. In the sidelink communications, DMRS follows a DMRS structure of a physical uplink shared channel (PUSCH) since LTE Rel. 10, that is, DMRS occupies two symbols in a subframe.

FIG. 2 is a schematic diagram of DMRS configuration in the sidelink communications, in which a DMRS pattern of a subframe (also referred to as a normal subframe) with normal cyclic prefix (CP) is shown. As shown in FIG. 2, synchronization signal appears every 40 ms, and in the subframe with normal CP, the DMRS occupies symbols of which indexes are 3 and 10, respectively.

FIG. 2 further gives positions and periods of the synchronization signal, which mainly include primary sidelink synchronization signal (PSS) and secondary sidelink synchronization signal (SSS). In the subframe with normal CP, the PSS and SSS respectively occupy symbols of which indexes are (1, 2) and symbols of which indexes are (11, 12). In addition, taking switch between transmission and reception needs times, a last symbol of each subframe is set to be blank (marked by X), that is, no signal is transmitted.

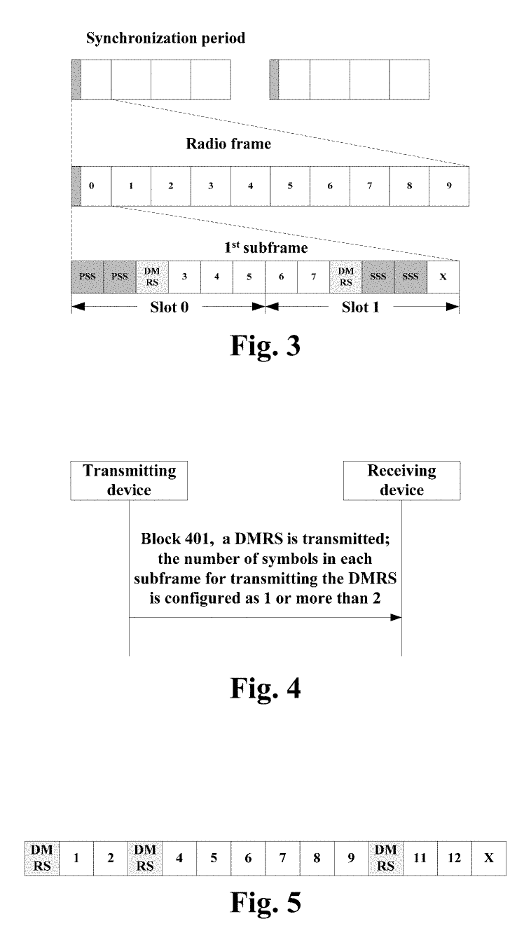

FIG. 3 is another schematic diagram of the DMRS configuration in the sidelink communications, in which a DMRS pattern of a subframe (also referred to as an extended subframe) with extended CP is shown. As shown in FIG. 3, synchronization signal appears every 40 ms, and in the subframe with extended CP, the DMRS occupies symbols of which indexes are 2 and 8, respectively.

FIG. 3 further gives positions and periods of the synchronization signal, which mainly include PSS and SSS. In the subframe with extended CP, the PSS and SSS respectively occupy symbols of which indexes are (0, 1) and symbols of which indexes are (9, 10). In addition, taking switch between transmission and reception needs times, a last symbol of each subframe is set to be blank (marked by X), that is, no signal is transmitted.

It can be seen from FIGS. 2 and 3, the number of symbols in each subframe used for transmitting the DMRS is always 2, and such a design is not changed even in case of sidelink, which because that the sidelink is like an original LTE uplink, in a corresponding application scenario of which the highest moving velocity is 120 km/h, in which case the two symbols transmitting the DMRS contained in each subframe may fully meet a demand for transmission performance.

However, in a new traffic application, such as V2X, what needs to be taken into account is that the highest velocity should reach 280 km/h, especially communications between two vehicles moving towards each other in the V2V application. Furthermore, in a new traffic application, such as the cellular IOT, cases where a moving velocity is relatively low or even static need to be taken into account. In order to deal with such applications, design of DMRS needs to be reconsidered.

### Embodiment 1

The embodiment of this disclosure provides a transmission method for a demodulation reference signal. FIG. 4 is a flowchart of the transmission method for the demodulation reference signal of Embodiment 1 of this disclosure. As shown in FIG. 4, the transmission method includes:

Block 401: a DMRS is transmitted by a transmitting device to a receiving device; the number of symbols in each subframe for transmitting the DMRS is configured as 1 or more than 2.

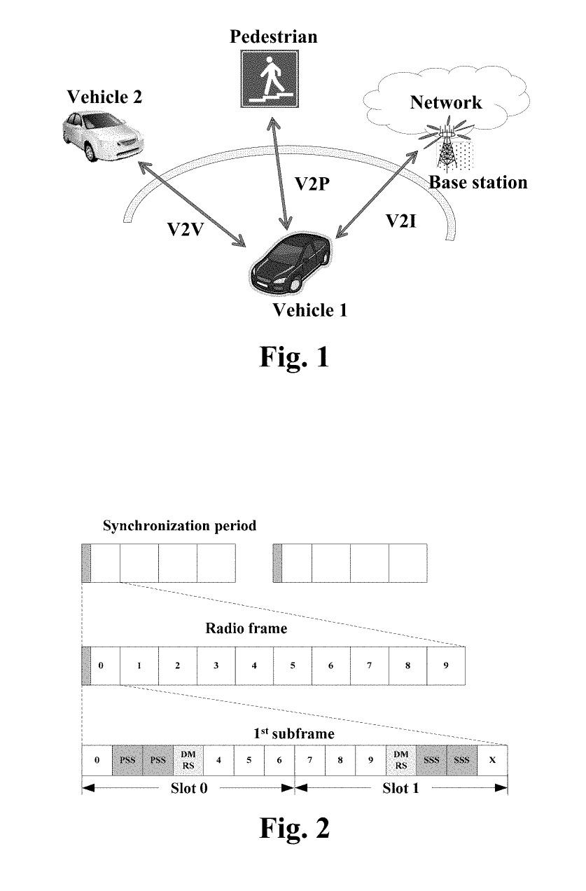

In this embodiment, the transmission method may be applied to the V2X communications. The transmitting device may be vehicle 1 shown in FIG. 1, and the receiving device may be vehicle 2, or the pedestrian, or the base station shown in FIG. 1; or the transmitting device may be vehicle 2, or the pedestrian, or the base station shown in FIG. 1, and the receiving device may be vehicle 1 shown in FIG. 1. However, this disclosure is not limited thereto; for example, the method of this disclosure may also be applied to other communications systems, such as the cellular IOT.

Following description shall be given by taking a V2X communications system and the cellular IOT as examples only.

In this embodiment, the symbols may be orthogonal frequency division multiplexing (OFDM) symbols or single-carrier frequency division multiple access (SC-FDMA) symbols, and the DMRS occupies the symbols in a full-bandwidth manner for transmission.

In one implementation, the subframe is a subframe with normal CP, and the symbols in each subframe with normal CP for transmitting the DMRS include symbols of which indexes are 0, 3 and 10.

FIG. 5 is a schematic diagram of a DMRS pattern in a subframe with normal CP in the embodiment of this disclosure. As shown in FIG. 5, in order to deal with a high velocity application, such as the V2X, a symbol for transmitting the DMRS may be added into an original DMRS design in an LTE system.

As shown in FIG. 5, in the subframe with normal CP, the symbols of which indexes are 0, 3 and 10 are used for transmitting the DMRS, the symbols transmitting the DMRS may employ a modulation scheme, such as SC-FDMA, and the DMRS occupies the symbols in a full-bandwidth manner for transmission.

In comparison of this implementation and the relevant art, the original symbols for transmitting the DMRS is not adjusted, and only a symbol for transmitting the DMRS is added to enhance channel estimation quality.

In another implementation, the subframe is a subframe with normal CP, and the symbols in each subframe with normal CP for transmitting the DMRS include symbols of which indexes are 0, 5 and 10.

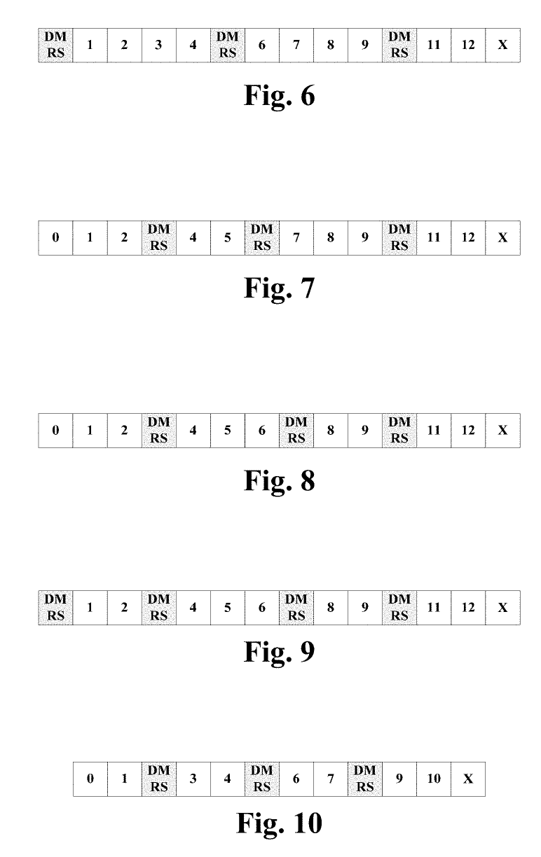

FIG. 6 is another schematic diagram of the DMRS pattern in the subframe with normal CP in the embodiment of this disclosure. As shown in FIG. 6, in the subframe with normal CP, the symbols of which indexes are 0, 5 and 10 are used for transmitting the DMRS, the symbols transmitting the DMRS may employ a modulation scheme, such as SC-FDMA, and the DMRS occupies the symbols in a full-bandwidth manner for transmission.

In this implementation, in comparison with the DMRS pattern in FIG. 5, distribution of the DMRS in a subframe is more uniform, which may not only increase a transmission density of the DMRS, but also make channel estimation quality better.

In another implementation, the subframe is a subframe with normal CP, and the symbols in each subframe with normal CP for transmitting the DMRS include symbols of which indexes are 3, 6 and 10.

FIG. 7 is a further schematic diagram of the DMRS pattern in the subframe with normal CP in the embodiment of this disclosure. As shown in FIG. 7, in the subframe with normal CP, the symbols of which indexes are 3, 6 and 10 are used for transmitting the DMRS, the symbols transmitting the DMRS may employ a modulation scheme, such as SC-FDMA, and the DMRS occupies the symbols in a full-bandwidth manner for transmission.

In this implementation, in comparison with the DMRS pattern in FIG. 5, distribution of the DMRS in a subframe is more uniform, which may not only increase a transmission density of the DMRS, but also make channel estimation quality better. And furthermore, a first symbol (i.e. the symbol of which an index is 0) is vacated for use in adjusting a radio frequency module in some cases.

In another implementation, the subframe is a subframe with normal CP, and the symbols in each subframe with normal CP for transmitting the DMRS include symbols of which indexes are 3, 7 and 10. And furthermore, a first symbol (i.e. the symbol of which an index is 0) is vacated for use in adjusting a radio frequency module in some cases.

FIG. 8 is still another schematic diagram of the DMRS pattern in the subframe with normal CP in the embodiment of this disclosure. As shown in FIG. 8, in the subframe with normal CP, the symbols of which indexes are 3, 7 and 10 are used for transmitting the DMRS, the symbols transmitting the DMRS may employ a modulation scheme, such as SC-FDMA, and the DMRS occupies the symbols in a full-bandwidth manner for transmission.

In this implementation, in comparison with the DMRS pattern in FIG. 5, distribution of the DMRS in a subframe is more uniform, which may not only increase a transmission density of the DMRS, but also make channel estimation quality better.

A case where there are three symbols for transmitting the DMRS in the subframe with normal CP is illustrated in the above implementation. And in order to deal with an extreme V2V application scenario, such as a velocity of 280 km/h, a DMRS design of four symbols may further be employed.

In still another implementation, the subframe is a subframe with normal CP, and the symbols in each subframe with normal CP for transmitting the DMRS include symbols of which indexes are 0, 3, 7 and 10.

FIG. 9 is yet another schematic diagram of the DMRS pattern in the subframe with normal CP in Embodiment 1 of this disclosure. As shown in FIG. 9, in the subframe with normal CP, the symbols of which indexes are 0, 3, 7 and 10 are used for transmitting the DMRS, and the symbols transmitting the DMRS may employ a modulation scheme, such as SC-FDMA. In comparison with a conventional scheme in which two symbols are used for DMRS transmission (as shown in FIG. 2), this implementation is equivalent to adding symbols of which indexes are 0 and 7.

In this implementation, in comparison with the above implementations where three symbols are used for DMRS transmission, the numbers of symbols of the DMRS pattern are identical in two slots, and the distribution is more uniform, which may not only increase a transmission density of the DMRS, but also make channel estimation quality better.

The cases where the subframe with normal CP are described above, and a subframe with extended CP shall be described below. In the subframe with extended CP, as the number of symbols in a subframe becomes less, it may be taken into account to add a symbol transmitting the DMRS to improve channel estimation quality.

In another implementation, the subframe is a subframe with extended CP, and the symbols in each subframe with extended CP for transmitting the DMRS include symbols of which indexes are 2, 5 and 8.

FIG. 10 is a schematic diagram of a DMRS pattern in the subframe with extended CP in the embodiment of this disclosure. As shown in FIG. 10, in the subframe with extended CP, the symbols of which indexes are 2, 5 and 8 are used for transmitting the DMRS, the symbols transmitting the DMRS may employ a modulation scheme, such as SC-FDMA, and the DMRS occupies the symbols in a full-bandwidth manner for transmission.

In this implementation, in comparison with a conventional scheme in which two symbols are used for DMRS transmission (as shown in FIG. 2), distribution of the DMRS in a subframe is more uniform, which may not only increase a transmission density of the DMRS, but also make channel estimation quality better.

The case where the number of symbols for transmitting the DMRS in each subframe is more than 2 is described above. And in this embodiment, the number of symbols for transmitting the DMRS in each subframe may be 1 only.

In another implementation, the subframe is a subframe with normal CP, and the symbol in each subframe with normal CP for transmitting the DMRS is a symbol of which an index is 6.

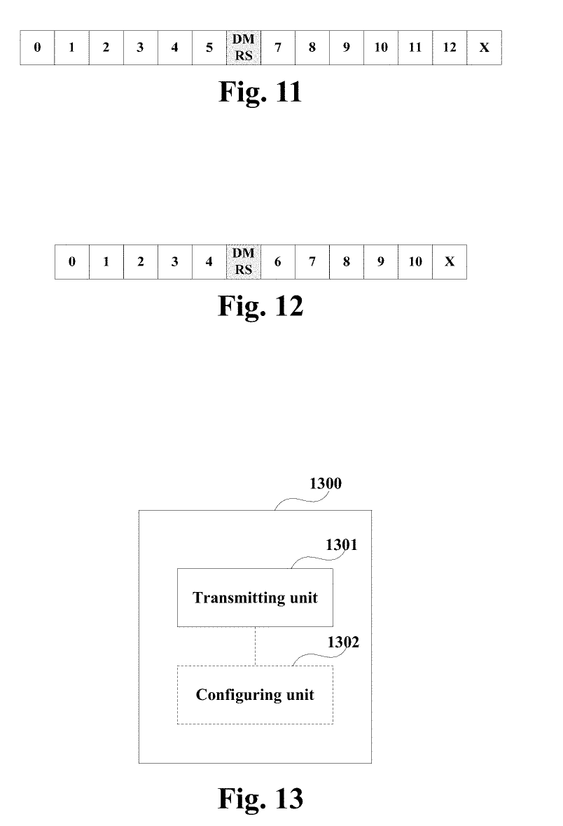

FIG. 11 is another schematic diagram of the DMRS pattern in the subframe with normal CP in the embodiment of this disclosure. As shown in FIG. 11, in the subframe with normal CP, the symbol of which index is 6 is used for transmitting the DMRS, the symbol transmitting the DMRS may employ a modulation scheme, such as SC-FDMA, and the DMRS occupies the symbol in a full-bandwidth manner for transmission.

Such a single-symbol DMRS configuration may be applicable to a relatively static system, such as a cellular IOT communications system, hence, a transmission density of DMRS may be reduced, overhead may be lowered, and waste of resources may be avoided.

In a further implementation, the subframe is a subframe with extended CP, and the symbol in each subframe with extended CP for transmitting the DMRS is a symbol of which an index is 5.

FIG. 12 is a further schematic diagram of the DMRS pattern in the subframe with extended CP in the embodiment of this disclosure. As shown in FIG. 12, in the subframe with extended CP, the symbol of which index is 5 is used for transmitting the DMRS, the symbol transmitting the DMRS may employ a modulation scheme, such as SC-FDMA, and the DMRS occupies the symbol in a full-bandwidth manner for transmission.

Such a single-symbol DMRS configuration may be applicable to a relatively static system, such as a cellular IOT communications system, hence, a transmission density of DMRS may be reduced, overhead may be lowered, and waste of resources may be avoided.

It should be noted that the DMRS patterns are illustrated above only. However, this disclosure is not limited thereto, and a particular DMRS pattern may be determined according to an actual situation.

In this embodiment, the transmitting device may configure multiple DMRS patterns, and the DMRS pattern may be as described above. And the transmitting device may transmit the DMRS according to one or more of the multiple DMRS patterns.

In particular, taking into account that a new traffic, such as the V2X, includes an application scenario where a velocity is very high (such as V2V), and also includes an application scenario where a velocity is relatively low (such as V2I), or a relatively static communications scenario, such as the cellular IOT, multiple DMRS patterns of different types may be considered and configured.

For example, for a subframe with normal CP, a DMRS pattern using three symbols (as shown in FIGS. 5-8), which are respectively referred to as DMRS pattern 1, DMRS pattern 2, DMRS pattern 3, DMRS pattern 4, may be configured and used; a DMRS pattern using four symbols (as shown in FIG. 9), which is referred to as DMRS pattern 5, may be configured and used; a DMRS pattern using two symbols used in an existing system (as shown in FIG. 2), which is referred to as DMRS pattern 6, may be configured and used; and a DMRS pattern using a single symbol (as shown in FIG. 11), which is referred to as DMRS pattern 7, may be configured and used.

And for a subframe with extended CP, a DMRS pattern using three symbols (as shown in FIG. 10), which is referred to as DMRS pattern 8, may be configured and used; a DMRS pattern using two symbols (as shown in FIG. 3), which is referred to as DMRS pattern 9, may be configured and used; and a DMRS pattern using a single symbol, which is referred to as DMRS pattern 10, may be configured and used.

It should be noted that how to configure multiple DMRS patterns is illustrated above. However, this disclosure is not limited thereto; for example, some of the DMRS patterns may be configured only, and a particular configuration manner may be determined according to an actual situation.

In this embodiment, the transmitting device may explicitly indicate configuration information on the DMRS patterns to the receiving device via high-layer signaling or physical layer signaling.

For example, the transmitting device is a base station, and the receiving device is UE, including various UE (a vehicle, infrastructure, and a hand-held terminal, etc.) in the V2X system, or various terminals in a cellular IOT system. The base station may indicate the UE to use DMRS pattern 1 (as shown in FIG. 5), or DMRS pattern 2 (as shown in FIG. 6) by using radio resource control (RRC) signaling or physical layer signaling, . . . .

Or, the configuration information on the DMRS patterns may be implicitly indicated to the receiving device via a synchronization signal. In this way, the base station transmitting the configuration information on the DMRS patterns to obtain the configuration of the DMRS may be avoided, and the configuration information on the DMRS patterns is implicitly indicated to the receiving device via a synchronization channel sequence according to a preset rule. As the synchronization channel is directly transmitted by a transmitting device of the V2X or the cellular IOT (such as a vehicle, infrastructure, a hand-held terminal, and a fixed terminal, etc.), a problem of DMRS configuration of the V2X communications or the cellular IOT out of coverage of the base station may be avoid.

For example, if a synchronization sequence is a value between 0-59, it implicitly indicates that DMRS pattern 5 using four symbols is configured (as shown in FIG. 9); if a synchronization sequence is a value between 60-119, it implicitly indicates that DMRS pattern 1 using three symbols is configured (as shown in FIG. 5); and if it is another value, it implicitly indicates that existing DMRS pattern 6 using two symbols is configured (as shown in FIG. 2).

Likewise, the configuration of DMRS patterns of the subframe with extended CP may be implicitly indicated.

It should be noted that how to indicate the configuration information on the DMRS patterns is illustrated above. However, indication rules of this disclosure are not limited thereto, and the configuration of the DMRS patterns may also be indicated in other manners agreed between the transmitting device and the receiving device.

It can be seen from the above embodiment that more than 2 symbols for transmitting the DMRS are configured in each subframe, which may increase a transmission density of DMRS, and satisfy a demand of a new traffic, such as V2X, for a moving speed; or a single symbol for transmitting the DMRS is configured in each subframe, which may satisfy a demand of a low-speed mobile traffic, such as the cellular IOT, and lower overhead.

### Embodiment 2

The embodiment of this disclosure provides a transmission apparatus for a demodulation reference signal, with contents identical to those in Embodiment 1 being not going to be described herein any further. FIG. 13 is a schematic diagram of the transmission apparatus for the demodulation reference signal of the embodiment of this disclosure. As shown in FIG. 13, the transmission apparatus 1300 includes:

a transmitting unit 1301 configured to transmit a DMRS to a receiving device; the number of symbols in each subframe for transmitting the DMRS is configured as 1 or more than 2.

In this embodiment, the transmission apparatus 1300 may be configured in a transmitting device of a V2X communications system, and may also be configured in a transmitting device of a cellular IOT system. And the symbols are OFDM symbols or SC-FDMA symbols, and the DMRS occupies the symbols in a full-bandwidth manner for transmission.

In one implementation, the subframe is a subframe with normal cyclic prefix; and the symbols in each subframe with normal cyclic prefix for transmitting the DMRS include symbols of which indexes are 0, 3 and 10, or symbols of which indexes are 0, 5 and 10, or symbols of which indexes are 3, 6 and 10, or symbols of which indexes are 3, 7 and 10, or symbols of which indexes are 0, 3, 7 and 10, or a symbol of which an index is 6.

In another implementation, the subframe is a subframe with extended cyclic prefix; and the symbols in each subframe with extended cyclic prefix for transmitting the DMRS include symbols of which indexes are 2, 5 and 8, or a symbol of which an index is 5.

As shown in FIG. 13, the transmission apparatus 1300 may further include:

a configuring unit 1302 configured to configure multiple DMRS patterns;

and the transmitting unit 1301 is further configured to transmit the DMRS according to one or more of the multiple DMRS patterns.

In this embodiment, the transmitting unit 1301 is further configured to indicate configuration information on the DMRS patterns to the receiving device via high-layer signaling or physical layer signaling;

or, the configuration information on the DMRS patterns is implicitly indicated to the receiving device via a synchronization signal.

The embodiment of this disclosure further provides a transmitting device, configured with the above transmission apparatus 1300. The transmitting device may be UE carried by a vehicle, may be UE carried by a pedestrian, or may also be a base station in infrastructure.

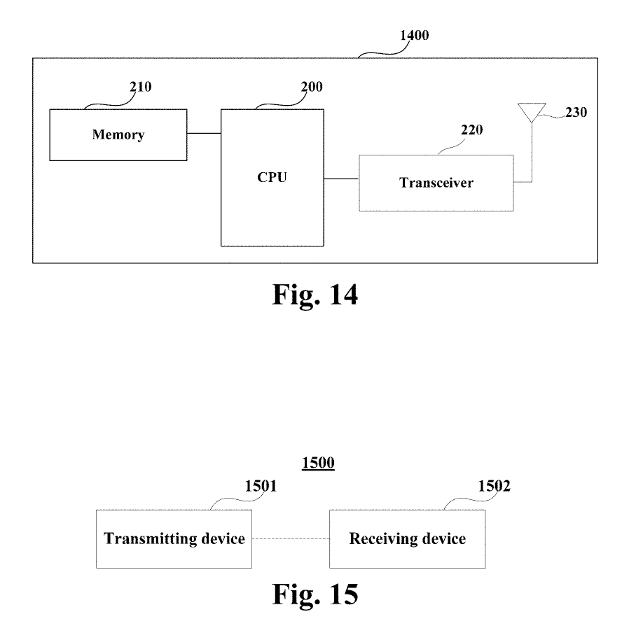

FIG. 14 is a schematic diagram of a structure of the transmitting device of the embodiment of this disclosure. As shown in FIG. 14, the transmitting device 1400 may include a central processing unit (CPU) 200 and a memory 210, the memory 210 being coupled to the central processing unit 200. The memory 210 may store various data, and furthermore, it may store a program for information processing, and execute the program under control of the central processing unit 200.

The functions of the transmission apparatus 1300 may be integrated into the central processing unit 200. The central processing unit 200 may be configured to carry out the transmission method for the demodulation reference signal described in Embodiment 1.

Furthermore, as shown in FIG. 14, the transmitting device 1400 may include a transceiver 220, and an antenna 230, etc. Functions of the above components are similar to those in the relevant art, and shall not be described herein any further. It should be noted that the transmitting device 1400 does not necessarily include all the parts shown in FIG. 14, and furthermore, the transmitting device 1400 may include parts not shown in FIG. 14, and the relevant art may be referred to.

It can be seen from the above embodiment that more than 2 symbols for transmitting the DMRS are configured in each subframe, which may increase a transmission density of DMRS, and satisfy a demand of a new traffic, such as V2X, for a moving speed; or a single symbol for transmitting the DMRS is configured in each subframe, which may satisfy a demand of a low-speed mobile traffic, such as the cellular IOT, and lower overhead.

### Embodiment 3

The embodiment of this disclosure provides a communications system, with contents identical to those in Embodiment 1 or 2 being not going to be described herein any further.

FIG. 15 is a schematic diagram of the communications system of the embodiment of this disclosure. As shown in FIG. 15, the communications system 1500 includes: a transmitting device 1501 and a receiving device 1502.

The transmitting device 1501 transmits a DMRS; the number of symbols in each subframe for transmitting the DMRS is configured as 1 or more than 2; and the receiving device 1502 receives the DMRS.

In this embodiment, the communications system may be a V2X communications system. And the symbols are OFDM symbols or SC-FDMA symbols, and the DMRS occupies the symbols in a full-bandwidth manner for transmission. However, this disclosure is not limited thereto, and the communications system may also be other communications systems, such as a cellular IOT.

An embodiment of the present disclosure further provides a computer readable program code, which, when executed in UE, will cause a computer unit to carry out the transmission method for the demodulation reference signal described in Embodiment 1 in the UE.

An embodiment of the present disclosure further provides a computer readable medium, including a computer readable program code, which will cause a computer unit to carry out the transmission method for the demodulation reference signal described in Embodiment 1 in UE.

An embodiment of the present disclosure further provides a computer readable program code, which, when executed in a base station, will cause a computer unit to carry out the transmission method for the demodulation reference signal described in Embodiment 1 in the base station.

An embodiment of the present disclosure further provides a computer readable medium, including a computer readable program code, which will cause a computer unit to carry out the transmission method for the demodulation reference signal described in Embodiment 1 in a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communications combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A transmission method for a demodulation reference signal (DMRS), comprising:
transmitting a DMRS by a transmitting device to a receiving device; wherein the number of symbols in each subframe for transmitting the DMRS is configured as 1 or more than 2.

2. The transmission method according to claim 1, wherein the symbols are orthogonal frequency division multiplexing (OFDM) symbols or single-carrier frequency division multiple access (SC-FDMA) symbols, and the DMRS occupies the symbols in a full-bandwidth manner for transmission.

3. The transmission method according to claim 1, wherein the subframe is a subframe with normal cyclic prefix, and the symbols in each subframe with normal cyclic prefix for transmitting the DMRS comprise symbols of which indexes are 0, 3 and 10.

4. The transmission method according to claim 1, wherein the subframe is a subframe with normal cyclic prefix, and the symbols in each subframe with normal cyclic prefix for transmitting the DMRS comprise symbols of which indexes are 0, 5 and 10.

5. The transmission method according to claim 1, wherein the subframe is a subframe with normal cyclic prefix, and the symbols in each subframe with normal cyclic prefix for transmitting the DMRS comprise symbols of which indexes are 3, 6 and 10.

6. The transmission method according to claim 1, wherein the subframe is a subframe with normal cyclic prefix, and the symbols in each subframe with normal cyclic prefix for transmitting the DMRS comprise symbols of which indexes are 3, 7 and 10.

7. The transmission method according to claim 1, wherein the subframe is a subframe with normal cyclic prefix, and the symbols in each subframe with normal cyclic prefix for transmitting the DMRS comprise symbols of which indexes are 0, 3, 7 and 10.

8. The transmission method according to claim 1, wherein the subframe is a subframe with normal cyclic prefix, and the symbols in each subframe with normal cyclic prefix for transmitting the DMRS comprise a symbol of which an index is 6.

9. The transmission method according to claim 1, wherein the subframe is a subframe with extended cyclic prefix, and the symbols in each subframe with extended cyclic prefix for transmitting the DMRS comprise symbols of which indexes are 2, 5 and 8.

10. The transmission method according to claim 1, wherein the subframe is a subframe with extended cyclic prefix, and the symbols in each subframe with extended cyclic prefix for transmitting the DMRS comprise a symbol of which an index is 5.

11. The transmission method according to claim 1, wherein the transmission method further comprises:
configuring multiple DMRS patterns by the transmitting device;
and the transmitting device transmits the DMRS according to one or more of the multiple DMRS patterns.

12. The transmission method according to claim 11, wherein the transmission method further comprises:
indicating configuration information on the DMRS patterns by the transmitting device to the receiving device via high-layer signaling or physical layer signaling.

13. The transmission method according to claim 11, wherein the configuration information on the DMRS patterns is indicated to the receiving device via a synchronization signal.

14. A transmission apparatus for a demodulation reference signal (DMRS), comprising:
a transmitting unit configured to transmit a DMRS to a receiving device; wherein the number of symbols in each subframe for transmitting the DMRS is configured as 1 or more than 2.

15. The transmission apparatus according to claim 14, wherein the symbols are OFDM symbols or SC-FDMA symbols, and the DMRS occupies the symbols in a full-bandwidth manner for transmission.

16. The transmission apparatus according to claim 14, wherein the subframe is a subframe with normal cyclic prefix;
and the symbols in each subframe with normal cyclic prefix for transmitting the DMRS comprise symbols of which indexes are 0, 3 and 10, or symbols of which indexes are 0, 5 and 10, or symbols of which indexes are 3, 6 and 10, or symbols of which indexes are 3, 7 and 10, or symbols of which indexes are 0, 3, 7 and 10, or a symbol of which an index is 6.

17. The transmission apparatus according to claim 14, wherein the subframe is a subframe with extended cyclic prefix;
and the symbols in each subframe with extended cyclic prefix for transmitting the DMRS comprise symbols of which indexes are 2, 5 and 8, or a symbol of which an index is 5.

18. The transmission apparatus according to claim 14, wherein the transmission apparatus further comprises:
a configuring unit configured to configure multiple DMRS patterns;
and the transmitting unit is configured to transmit the DMRS according to one or more of the multiple DMRS patterns.

19. The transmission apparatus according to claim 18, wherein the transmitting unit is further configured to indicate configuration information on the DMRS patterns to the receiving device via high-layer signaling or physical layer signaling;
or, the configuration information on the DMRS patterns is indicated to the receiving device via a synchronization signal.

20. A communications system, comprising:
a transmitting device configured to transmit a DMRS; wherein the number of symbols in each subframe for transmitting the DMRS is configured as 1 or more than 2; and
a receiving device configured to receive the DMRS.
